(19) United States
(12) Patent Application Publication
(10) Pub. No.: US 2025/0035381 A1
(43) Pub. Date: Jan. 30, 2025

(54) METHOD AND SYSTEM FOR HEATING PROCESS LIQUID USED IN A SLURRY STREAM IN AN ALCOHOL PRODUCTION PROCESS

(71) Applicant: Fluid Quip Technologies, LLC, Cedar Rapids, IA (US)

(72) Inventor: Aaron Rud, Marion, IA (US)

(21) Appl. No.: 18/784,745

(22) Filed: Jul. 25, 2024

Related U.S. Application Data
(60) Provisional application No. 63/516,218, filed on Jul. 28, 2023.

(51) Int. Cl. F28B 3/06

(52) U.S. Cl. CPC F28B 3/06

(57) ABSTRACT

A method and system for heating process liquid used in a slurry stream in an alcohol production process. A portion of direct inject steam typically intended for a slurry tank, such as in a dry milling process, can be (re)directed to first effect evaporators to produce a greater steam input than is typical. The additional pounds of steam produces a corresponding additional volume of first effect evap steam that can be captured and directed to an eductor on a front end of the dry milling process. That first effect steam mixes with and further heats incoming process liquid, which now further includes condensed first effect steam. This heated mixture is combined with milled corn to provide a heated slurry stream, which is sent on to a slurry tank and further subjected to direct inject steam, in a smaller weight by volume than is typical, to provide a desired slurry temperature.

### TECHNICAL FIELD

The present invention relates generally to producing alcohol (e.g., ethanol) and/or other biofuels/biochemicals and, more specifically, to a method and system for heating process liquid used in a slurry stream in an alcohol production process.

### BACKGROUND

Fuel grade alcohol (e.g., ethanol) distilled from grain (e.g., corn) has become increasingly popular as an alternative to gasoline. Additionally, ethanol has increased in popularity as a gasoline additive for formulating clean burning grades of gasoline for motor vehicles.

One method of producing alcohol (e.g., ethanol) includes using corn wet milling. Wet mill corn processing plants convert corn grain into several different natural co-products, such as germ (for oil extraction), gluten feed (high fiber animal feed), gluten meal (high protein animal feed), and starch-based products, including ethanol, high fructose corn syrup, or food and industrial starch. Constructing wet-milling plants is complex and capital-intensive, and operating them is operationally complex and energy intensive.

Dry-mill alcohol (e.g., ethanol) plants alternatively have a much lower capital cost to build and lower operating cost to operate compared to a wet mill process. A typical corn dry milling process consists of four major steps: grain handling and milling, liquefaction/cooking and saccharification, fermentation and distillation, and co-product recovery. Grain handling and milling is the step in which the corn is brought into the plant and ground to promote better conversion of starch to glucose. Liquefaction/cooking is the step of converting solids, such as starch, to a flowable liquid (or slurry stream) producing oligosaccharides while heating (cooking) the slurry, and saccharification is where the oligosaccharides are converted into single glucose molecules. Fermentation is the process of yeast or bacteria, or as clostridia, for example, converting glucose into a biofuel or a biochemical, such as ethanol. Distillation is the process of removing the biofuel or biochemical, such as ethanol, from the fermentation product. Co-product recovery is the step in which the corn by-products are de-watered and made ready for market. There are many known chemical and biological conversion processes known in the art that utilize yeast, bacteria, or the like to convert glucose to other biofuels and biochemical components like ethanol, for example.

The recovery of alcohol, e.g., ethanol, butanol, etc., and natural co-products generally begins with the beer (spent fermentation broth) being sent to a distillation system. With distillation, ethanol is typically separated from the rest of the beer through a set of stepwise vaporizations and condensations. To produce fuel grade ethanol, more than one interconnected distillation column is typically used to progressively purify the ethanol product. In a typical ethanol distillation process, a beer column receives beer and produces an intermediate ethanol vapor. A rectifier column receives the intermediate ethanol vapor from the beer column and produces 190 proof or 95% pure ethanol vapor. A third, side stripper column receives bottoms from the rectifier column and then produces an intermediate ethanol overhead vapor that is further purified by the rectifier column. The ethanol free bottoms from the side stripper column can be used to formulate cook water for the fermentation portion of the process. Because of the physical properties of an ethanol water solution, a distillation process can only practically produce an ethanol water solution that is approximately 95% ethanol and 5% water. A dehydrator is used to remove most of the remaining water to produce higher purity product. The dehydrator receives the 95% ethanol vapor and removes nearly all of the remaining water to produce ethanol having a water content typically of less than about 1.0%.

A fuel grade ethanol distillation process like the one described above also produces co-products. To that end, the beer less the alcohol extracted through distillation is known as whole stillage, which contains a slurry of the spent grains including corn protein, fiber, oil, minerals, and sugars as well as spent fermentation agent. These byproducts are too diluted to be of much value at this point and are further processed to provide the dried distiller's grains with solubles (DDGS). In typical processing, when the whole stillage leaves the distillation column, it is generally subjected to a decanter centrifuge to separate insoluble solids or “wet cake”, which includes mostly fiber, from the liquid or “thin stillage”, which includes, e.g., protein, fine fiber, oil, and amino acids. A portion of the thin stillage can be used as “backset” to help produce the slurry stream. After separation, the thin stillage moves to stillage evaporators to boil away moisture, leaving a thick syrup that contains soluble (dissolved) solids. The concentrated syrup can be mixed with the wet cake, and the mixture may be sold to beef and dairy feedlots as distillers wet grain with solubles (DWGS). Alternatively, the wet cake and concentrated syrup mixture may be dried in a drying process and sold as distillers dried grain with solubles (DDGS). The resulting DDGS generally has a crude protein content of about 32% and is a useful feed for cattle, other ruminants, and monogastric animals due to its protein and fiber content. The resulting product is a natural product.

A typical alcohol (e.g., ethanol) production process requires significant energy input as well as a significant amount of process water. It would be beneficial to provide a method and system for producing alcohol that conserves energy and water by utilizing waste heat from the stillage evaporators to more efficiently heat other portions of the process, including the process liquid used in the slurry stream at the front end of the alcohol production process.

### SUMMARY

The present invention relates to producing alcohol (e.g., ethanol) and/or other biofuels/biochemicals and, more specifically, relates to a method and system for more efficiently heating process liquid used in a slurry stream in an alcohol production process.

In one embodiment, a portion of direct inject steam typically intended for a slurry tank, such as in a dry milling process, can be eliminated and, instead, directed to first effect evaporators to provide a greater steam input than is typical in a corn dry milling process. By way of example, 18 lbs/bu of steam from a plant boiler can be provided to first effect evaporators instead of, for example, a standard 16 lbs/bu by (re)directing an additional 2 lbs/bu of inject steam typically intended for the slurry tank. The additional pounds, e.g., 2 lbs/bu, of steam produces a corresponding additional 2 lbs/bu of first effect evap steam that can be captured and directed to an eductor on the front end of the dry milling process. That first effect steam mixes with and further heats incoming process liquid, which here is heated cook water and a backset mixture. The heated process liquid, which now further includes condensed first effect steam, is combined with milled corn to provide a (more efficiently) heated slurry stream.

The slurry stream then is sent on to a slurry tank and further subjected to direct inject steam, but in a now smaller weight by volume than is typical, to provide a desired slurry temperature at the tank. Again, a typical 4 lbs/bu steam injection, for example, that is traditionally intended for the slurry tank can be reduced to 2 lbs/bu due to the sending of additional steam to the first effect evaporators and, ultimately, to the eductor. In this manner, there is a resulting reduction in water added to the overall alcohol production process through the use of the waste heat (first effect steam) from the stillage evaporators and using the same at the eductor to increase the temperature of the incoming process liquid and ultimately the slurry stream. And this reduces cost/conserves energy such as by reducing the amount of total liquid required to be evaporated at the evaporators. Energy savings, for example, can be taken at the dryer(s) on the back end of the process if the evaporators can be taken to higher dried solids. In addition, greater oil yield can be realized for an increase in revenue.

In another embodiment, a method for heating a process liquid used in a slurry stream in a biofuel and/or biochemical (e.g., an alcohol) production process is provided that includes separating thin stillage from whole stillage in a biofuel and/or biochemical production process followed by evaporating liquid from a first portion of the separated thin stillage via one or more evaporators to produce steam. Next, a process liquid is heated, which includes a mixture of a second portion of the separated thin stillage and a liquid portion, with a portion of the steam at an eductor whereat the steam mixes with and heats the process liquid, and the steam cools and condenses to liquid thereby providing a heated process liquid, including a mixture of the liquid portion, the second portion of thin stillage, and condensed steam. Then, the heated process liquid is mixed with a ground grain to provide a heated slurry stream. In one example, the steam is first and/or second effect steam. In another example, the liquid portion is a heated liquid portion.

In another embodiment, a method for heating a process liquid used in a slurry stream in a biofuel and/or biochemical (e.g., an alcohol) production process is provided that includes separating thin stillage from whole stillage in a biofuel and/or biochemical production process followed by evaporating liquid from a first portion of the separated thin stillage via one or more evaporators to produce a first effect steam. Next, a process liquid is heated, which includes a mixture of a second portion of the separated thin stillage and a heated liquid portion, with a portion of the first effect steam at an eductor whereat the first effect steam mixes with and further heats the process liquid, and the first effect steam cools and condenses to liquid thereby providing a heated process liquid, including a mixture of the heated liquid portion, the second portion of thin stillage, and condensed first effect steam. Then, the heated process liquid is mixed with a ground grain to provide a heated slurry stream.

In still another example, a system for heating a process liquid used in a slurry stream in a biofuel and/or biochemical (e.g., an alcohol) production process is provided that includes a first apparatus that receives whole stillage and separates thin stillage from the whole stillage, and includes one or more evaporators that receive all or a portion of the separated thin stillage from the first apparatus, the one or more evaporators configured to evaporate water from the separated thin stillage and produce steam. The system further includes an eductor that receives a process liquid, which includes a mixture of a second portion of the separated thin stillage and a liquid portion, and a portion of the steam, whereat the steam mixes with and heats the process liquid, and the steam cools and condenses to liquid thereby providing a heated process liquid, including a mixture of the liquid portion, the second portion of thin stillage, and condensed first effect steam. The system also includes a second apparatus that receives the heated process liquid and a ground grain and whereat the heated process liquid is mixed with the ground grain to provide a heated slurry stream. In one example, the first apparatus can be selected from a centrifuge and the second apparatus can be selected from a slurry blender. In another example, the steam is first effect steam. In still another example, the liquid portion is a heated liquid portion.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a flow diagram of a prior art dry-milling method and system for producing alcohol;

FIG. 2 is a flow diagram of a dry-milling method and system for heating process liquid used in a slurry stream in an alcohol production process in accordance with an embodiment of the invention;

FIG. 3 is a schematic of the eductor, in cross-section, and the process flow surrounding the eductor in the method and system of FIG. 2 in accordance with an embodiment of the invention; and

FIG. 4 is a flow diagram of the back end of the method and system of FIG. 2 showing details of the distillation and dehydration, centrifugation, and evaporation steps in accordance with an embodiment of the invention.

### DETAILED DESCRIPTION OF SPECIFIC EMBODIMENTS

The present invention relates to producing alcohol (e.g., ethanol) and/or other biofuels/biochemicals and, more specifically, to a method and system for heating process liquid used in a slurry stream in an alcohol production process by utilizing a portion of waste heat from stillage evaporators and combining that waste heat with process liquid (e.g., backset and cook water) at an eductor to efficiently heat the process liquid used in a slurry stream at the front end of the alcohol production process. This setup, as is explained in greater detail below, can provide an overall reduction in water added to the alcohol production process and, in turn, reduces cost and conserves energy.

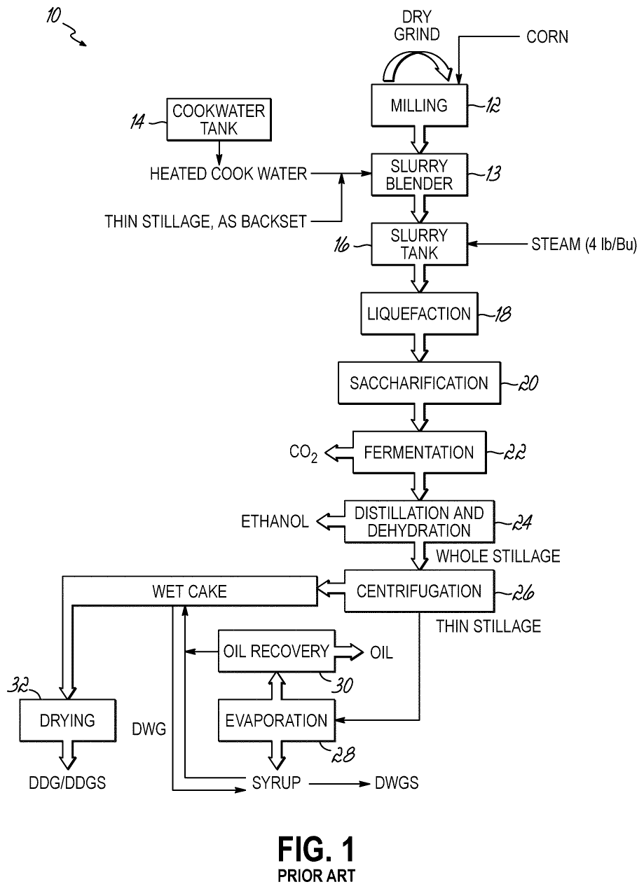

FIG. 1 shows a flow diagram of a typical dry milling alcohol (e.g., ethanol) production process 10. Although virtually any type and quality of grain, such as but not limited to sorghum, wheat, triticale, barley, rye, tapioca, cassava, potato, and other grains can be used to produce ethanol, for example, the feedstock for this process is typically corn referred to as “No. 2 Yellow Dent Corn.” Also, as a general reference point, the dry milling method 10 can be divided into a front end and a back end. The part of the method 10 that occurs prior to distillation and dehydration 24 is considered the “front end,” and the part of the method 10 that includes and occurs after distillation and dehydration 24 is considered the “back end.” To that end, the front end of the dry milling process 10 begins with a milling step 12 in which dried whole corn kernels can be passed through hammer mills for grinding/milling into meal or a fine powder.

After the milling step 12, the ground meal is mixed or blended at the slurry blender 13 with process liquid including heated cook water (from a cook water tank 14) and backset, which can be a portion of thin stillage returned from the back end of the process 10, to create a slurry. The cook water can be fresh water or a liquid that is received from another area/stream of the process 10, similar to the backset. After mixing at the slurry blender 13, the slurry stream is sent to a slurry tank 16 and a commercial enzyme called alpha-amylase is typically added (not shown) along with direct inject process steam, such as from the plant boiler, at about 4 lbs/bu to increase the temperature of the slurry to a desired temperature. After the slurry tank 16, the slurry stream is subjected to a liquefaction step 18 to convert the insoluble starch in the slurry to soluble starch.

Liquefaction 18 may be followed by separate saccharification and fermentation steps, 20 and 22, respectively, although in most commercial dry grind ethanol processes, saccharification and fermentation can occur simultaneously. This single step is referred to in the industry as “Simultaneous Saccharification and Fermentation” (SSF). Fermentation converts the sugar to alcohol. Yeast from the fermentation process generally pass through to the distillation and dehydration step 24, which utilizes a still to recover the alcohol.

Finally, a centrifugation step 26 involves centrifuging the residuals, i.e., “whole stillage”, which includes non-fermentable components such as protein, oil, ash, minerals, and yeast yielded from the distillation and dehydration step 24, in order to separate the insoluble solids (“wet cake”) from the liquid (“thin stillage”). The thin stillage typically enters evaporators in an evaporation step 28 in order to boil or flash away moisture, leaving a thick syrup which contains the soluble (dissolved) solids (mainly protein and starches/sugars) from the fermentation (25 to 40% dry solids) along with residual oil and fine fiber. The concentrated slurry can be sent to a centrifuge to separate the oil from the syrup in an oil recovery step 30. The oil can be sold as a separate high value product. The oil yield is normally about 0.7 lb/bu of corn with elevated free fatty acids content compared to traditional wet mill corn oil. This oil yield recovers only about ⅓ of the oil in the corn, with part of the oil passing with the syrup stream and the remainder being lost with the fiber/wet cake stream. About one-half of the oil inside the corn kernel remains inside the germ after the distillation step 24, which cannot be separated in the typical dry grind process using centrifuges as the oil is bound, not free. The free fatty acids content, which is created when the oil is heated and exposed to oxygen throughout the front and back-end process, reduces the value of the oil. The (de-oil) centrifuge only removes less than 50% because the protein and oil make an emulsion, which cannot be satisfactorily separated without the use of chemicals or added mechanical separation unit operations.

The syrup, which has more than 10% oil, can be mixed with the centrifuged wet cake, and the mixture may be sold to beef and dairy feedlots as Distillers Wet Grain with Solubles (DWGS). Alternatively, the wet cake and concentrated syrup mixture may be dried in a dryer at a drying step 32 and sold as Distillers Dried Grain with Solubles (DDGS) to dairy and beef feedlots. This DDGS has all the corn and yeast protein and about 67% of the oil in the starting corn material. But the value of DDGS is low due to the high percentage of fiber, and in some cases the oil is a hindrance to animal digestion and lactating cow milk quality.

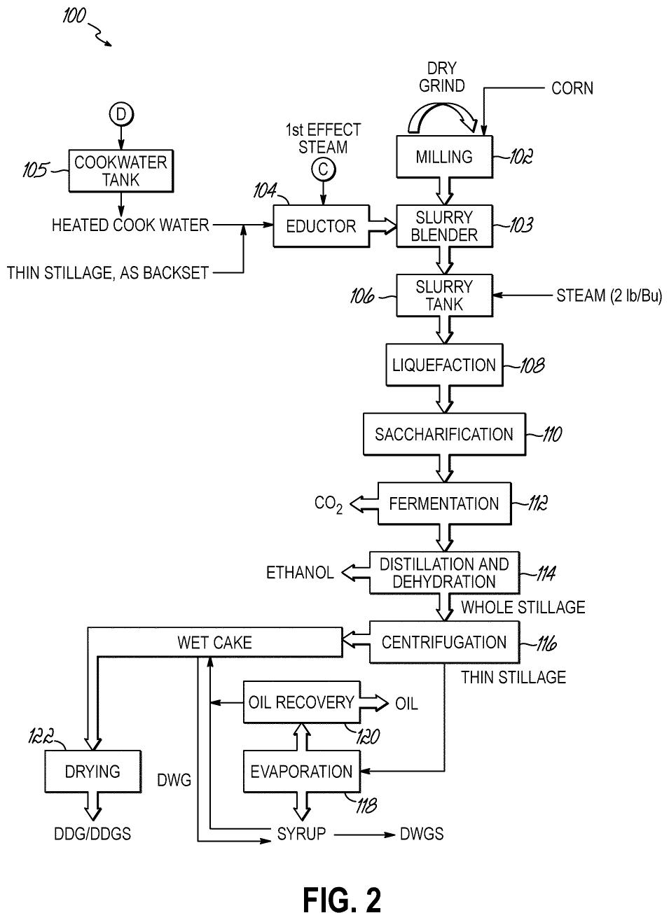

In accordance now with the present invention, FIG. 2 schematically illustrates an embodiment of a dry-milling method and system, collectively numeral 100, for producing alcohol, e.g., ethanol, in a grain dry-milling process, such as a corn or similar grain dry-milling process, and in certain respects not unlike a typical corn dry-milling process 10 similar to that just described in FIG. 1, but with modifications to various aspects of that process 10, including to the front and back ends thereof, such as by heating (via an eductor) process liquid used in a slurry stream along with various other modifications, as discussed in detail below, in an effort to conserve energy and reduce alcohol production costs.

In one embodiment, the method and system 100 begins with a milling step 102 in which dried whole corn kernels can be passed through hammer mills for grinding/milling into meal or a fine powder. Although virtually any type and quality of grain, such as but not limited to sorghum, wheat, triticale, barley, rye, tapioca, cassava, potato, and other grains can be used to produce ethanol, for example, the feedstock for this process is typically corn referred to as “No. 2 Yellow Dent Corn.” Other milling devices such as roller mills or pin mills can also be utilized in the milling step 12. The screen openings in the hammer mills or similar devices typically can be of a size 6/64 to 9/64 inch, or about 2.38 mm to 3.57 mm, but some plants can operate at less than or greater than these screen sizes. The resulting particle distribution yields a very widely spread, bell type curve, which includes particle sizes as small as 45 microns and as large as 2 mm to 3 mm. The majority of the particles generally can be in the range of 500 to 1200 microns, which can be the “peak” of the bell curve.

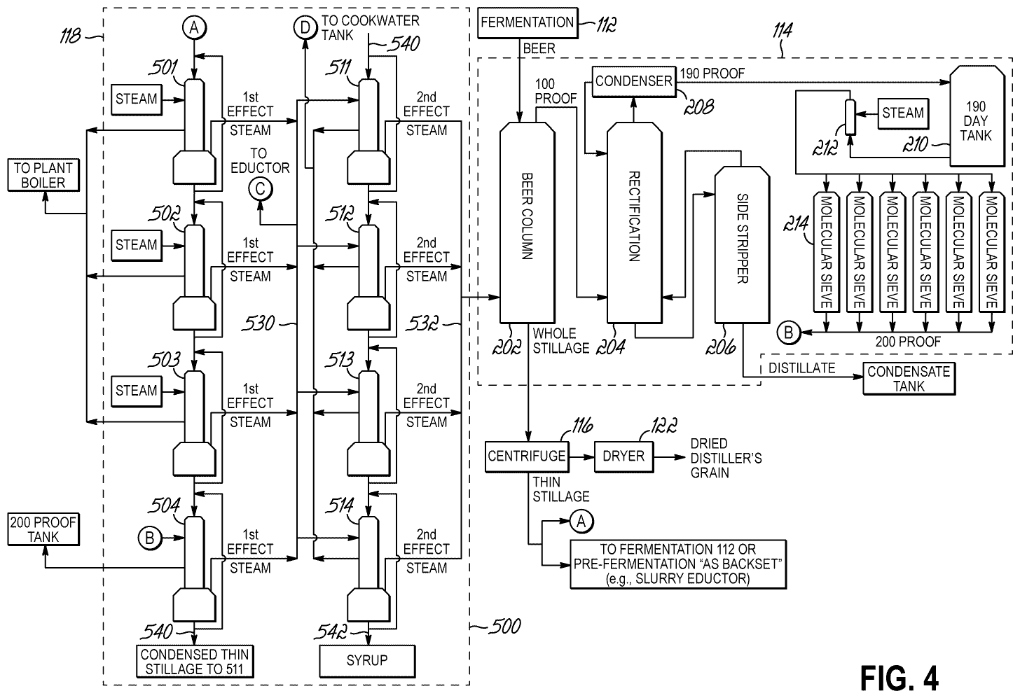

After the milling step 102, the ground meal is mixed or blended at a slurry blender 103 with heated process liquid, via an eductor 104, including a combination of heated cook water, backset, and condensed first effect steam. In one example, the slurry blender can be a screw conveyor, auger device, and the like as are known in the art. As shown in FIGS. 2 and 4, first effect evap steam, which can be at a temperature of about 200° F. and discussed in greater detail below, can be directed to the eductor 104 (also generally known as a jet pump) from one or more of the first effect evaporators 501, 502, 503, 504 (see FIG. 4) whereat the first effect steam mixes with and further heats an incoming heated cook water (from a cook water tank 105) and backset mixture and whereat the steam cools and condenses to liquid. The cook water initially can be provided to the cook water tank 105 as evap condensate from one or more of the second effect evaporators 511, 512, 513, 514 (see FIG. 4). In another example, the cook water can be fresh water or a liquid that is received from another area/stream of the process 100. The cook water at the cook water tank can be at a temperature of about 155° F. to about 195° F. Prior to the eductor 104, the cook water from the cook tank 105 can be heated by means and methods known in the art, such as by a heater, heating coil, and the like. In one example, the cook water can be further heated to a temperature from about 185° F. to about 215° F. The backset can be a portion of thin stillage returned from the back end of the process 100, to help create a slurry stream, as is further discussed below. The backset from the back end initially can be provided at a temperature from about 150° F. to about 185° F. In one example, the backset may be combined with the cook water directly at the cookwater tank 105. As shown, the heated outgoing process liquid, with its cook water, backset, and steam condensate, is directed from the eductor 105 to the slurry blender 103 whereat the heated process liquid is combined with the milled corn to provide a heated slurry stream, which is sent on to a slurry tank 106. In one example, the heated process liquid can be heated up to a temperature from about 195° F. to about 205° F. In another example, the heated process liquid can be heated to a temperature of about 200° F. when it is blended at the slurry blender 103 with the milled grains.

After mixing of the heated process liquid and milled grain at the slurry blender 103, the slurry stream is sent to a slurry tank 106. Here, a commercial enzyme called alpha-amylase is typically added along with process steam, such as from the plant boiler (not shown), at a reduced volume of about 2 lbs/bu (instead of 4 lbs/bu) to increase the temperature of the slurry to a desired temperature, e.g., to about 190° F. In one example, the slurry temperature can be from about 175° F. to about 187° F. In another example, the slurry temperature can be from about 180° F. to about 187° F. While a reduction in steam of 2 lbs/bu is indicated, it should be understood that more or less steam can be considered, e.g., a 1 lb/bu or 3 lbs/bu reduction, as needed/desired. Generally, the reduction in steam here will be offset by an equivalent increase in steam input at one or more of the first effect evaporators 501, 502, 503, 504 (see FIG. 4), as discussed in more detail further below. At the slurry tank 106, the slurry stream is subjected to direct inject steam at a smaller weight per volume of slurry than is typical because of the (re)directing of steam to one or more of the first effect evaporators 501, 502, 503, 504 (see FIG. 4), discussed in greater detail below, and, ultimately, to the eductor 104. In this manner, there is a resulting reduction in water added to the overall alcohol production process 100 through the use of the waste heat (first effect steam) from one or more of the first effect evaporators 501, 502, 503, 504 and using the same at the eductor 104 to increase the temperature of the process liquid and, thus, the slurry stream. And this reduces cost/conserves energy. In particular, energy savings, for example, can be taken at the dryer(s) 122 on the back end of the process if the evaporators can be taken to higher dried solids. In addition, greater oil yield can be realized for an increase in revenue.

After the slurry tank 106, the slurry stream is subjected to a liquefaction step 108 to convert the insoluble starch in the slurry to soluble starch. During liquefaction, the pH can be adjusted to about 4.8 to 5.8 and the temperature maintained between about 50° C. to 105° C. so as to convert the insoluble starch in the slurry to soluble starch. The stream after the liquefaction step 18 has about 30% dry solids (DS) content, but can range from about 29-36%, with all the components contained in the corn kernels, including starch/sugars, protein, fiber, starch, germ, grit, oil, and salts, for example. Higher solids are achievable, but this requires extensive alpha amylase enzyme to rapidly breakdown the viscosity in the initial liquefaction step. There generally are several types of solids in the liquefaction stream: fiber, germ, and grit.

Liquefaction 108 may be followed by separate saccharification and fermentation steps, 110 and 112, respectively, although in most commercial dry grind ethanol processes, saccharification and fermentation can occur simultaneously. This single step is referred to in the industry as “Simultaneous Saccharification and Fermentation” (SSF). Both saccharification and SSF can take as long as about 50 to 60 hours. Fermentation converts the sugar to alcohol. In particular, glucoamylase is typically added to the fermentation step 112 to facilitate the breakdown of the starches and larger polysaccharides into monomers or single sugar molecules that the yeast can convert to ethanol (or other similar alcohols) while also producing carbon dioxide. In addition to glucoamylase, other enzymes can be added to the fermentation step 112 (as well as before or after fermentation), such as but not limited to phytase, protease, cellulase, hemicellulase, xylanase, gluconase, and the like to further enhance protein and/or oil recovery. Yeast from the fermentation process generally pass through to the distillation and dehydration step 114. Yeast can optionally be recycled in a yeast recycling step (not shown) either during the fermentation process or at the very end of the fermentation process. Subsequent to the fermentation step 112 is the distillation and dehydration step 114, which utilizes a still to recover the alcohol.

Next, a centrifugation step 116 involves centrifuging the residuals, i.e., “whole stillage”, which includes non-fermentable components such as protein, oil, ash, minerals, and yeast yielded from the distillation and dehydration step 114, in order to separate the insoluble solids (“wet cake”) from the liquid (“thin stillage”). The liquid from the centrifuge contains about 5% to 12% DS. The “wet cake” includes fiber, of which there generally are three types: (1) pericarp, with average particle sizes typically about 1 mm to 3 mm; (2) tipcap, with average particle sizes about 500 micron; (3) and fine fiber, with average particle sizes of about 250 microns. There may also be proteins and yeast bodies (inactive or lysed yeast), with a particle size of about 45 microns to about 300 microns. The fiber and other fractions may contain bound protein that is chemically and or physically attached to the fiber and other fraction.

The thin stillage typically enters evaporators in an evaporation step 118 in order to boil or flash away moisture, leaving a thick syrup which contains the soluble (dissolved) solids (mainly protein and starches/sugars) from the fermentation (25 to 40% dry solids) along with residual oil and fine fiber. The concentrated slurry can be sent to a centrifuge to separate the oil from the syrup in an oil recovery step 120. The oil can be sold as a separate high value product. Here, the oil yield can be from about 0.7 lb/bu of corn up to about 1.2 lb/bu with elevated free fatty acids content compared to traditional wet mill corn oil. The syrup can be mixed with the centrifuged wet cake, and the mixture may be sold to beef and dairy feedlots as Distillers Wet Grain with Solubles (DWGS). Alternatively, the wet cake and concentrated syrup mixture may be dried in a dryer at a drying step 122 and sold as Distillers Dried Grain with Solubles (DDGS) to dairy and beef feedlots.

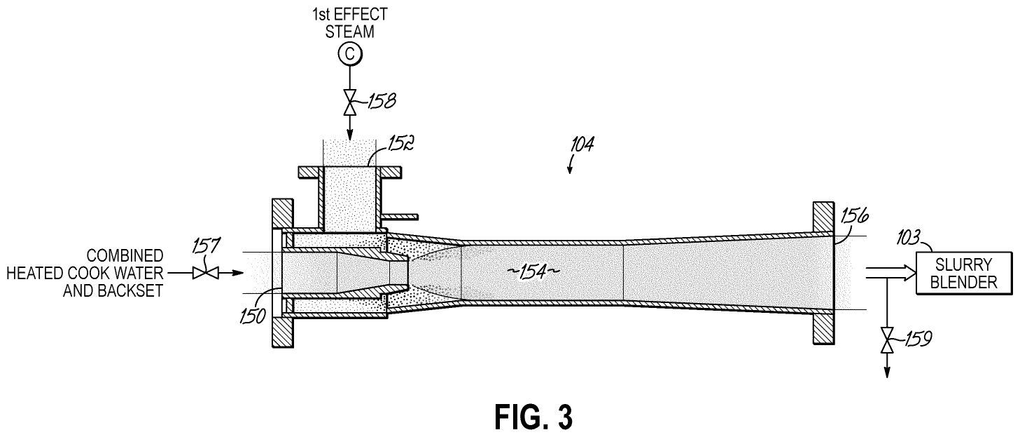

Further concerning the eductor 104 and with reference now to FIGS. 2 and 3, the eductor 104 can be any traditional/conventional type of eductor used for combining steam and liquids and are typically composed of metal, such as cast or stainless steel, titanium, and the like, or synthetic materials, such as thermoplastics (e.g., fluorinated thermoplastics, such as PTFE), and the like. The eductor 104 uses the principle of fluid dynamics to create a vacuum or generate flow in a fluid system and operates based on the Venturi effect, which states that when a liquid flows through a constricted section of a pipe, its velocity increases, and its pressure decreases. The efficiency and performance of the eductor 104 can depend or be effected by factors such as the design of the eductor, including its liquid inlet 150, and the pressure and flow rate of the process liquid and/or first effect steam, for example. Examples of suitable eductors 104 include the Penberthy Series of Jet Pumps (e.g., models LL, LM, LH, GL, or GH) available from Emerson Electric Co. of St. Louis, Missouri. In another example, the eductor 104 can be replaced by a heat exchanger and the like.

As best shown in FIG. 3, the incoming process liquid, which includes the combined heated cook water and backset, can be introduced to the eductor 104 via the liquid inlet 150 and the first effect steam introduced via a steam inlet 152. The liquid inlet 150 is a constricted section through which the incoming process fluid flows. The cook water and backset enters the eductor through the liquid inlet 150 at a high velocity and under high pressure. As the incoming process fluid passes through the constricted section, its velocity increases and its pressure decreases according to Bernoulli's principle. The first effect steam and the process liquid mix together within a mixing chamber 154 with the first effect steam heating the combined cook water and backset and whereat the steam cools and condenses to liquid. The reduced pressure in the mixing chamber 154 creates a pressure differential between the incoming process fluid and first effect steam. This pressure differential causes the first effect stream to be drawn into the mixing chamber 154 of the eductor 104. As the first effect steam enters the mixing chamber 154, it mixes with the incoming process fluid. The high-velocity process fluid imparts kinetic energy to the first effect steam, accelerating it. The outgoing process liquid, now with steam condensate, is discharged via a discharge outlet 156 and sent to the slurry blender 103, as discussed above, to mix with the ground grain to produce the slurry. The discharge outlet 156 is a gradually expanding section that allows the outgoing process liquid to slow down and regain pressure. There also can be valves 157 and 158, respectively, situated prior to the liquid inlet 150 to control the flow of the incoming process liquid and situated prior to the steam inlet 152 to control the incoming first effect steam. In addition, there can be a valve 159 situated after the discharge outlet 156 to provide for pressure relief, as needed, for the exiting/outgoing steam heated process fluid.

As indicated above, a portion of direct inject steam (typically intended for a slurry tank in a conventional dry milling process) can be (re)directed to first effect evaporators 501, 502, 503 on the back end of the method and system 100 from a plant boiler (not shown), as discussed further below, to produce a greater steam input to the first effect evaporators 501, 502, 503 than is typical in a corn dry milling process. The additional pounds, e.g., 2 lbs/bu, of steam produces a corresponding additional 2 lbs/bu of first effect evap steam that can be captured and directed to the eductor 104 on the front end of the dry milling method and system 100. This overall setup on the back end of the method and system 100, which includes the distillation and dehydration step 114, centrifugation step 116, and evaporation step 118, is best shown in FIG. 4, and is explained in greater detail next.

With reference to FIG. 4, the distillation and dehydration step 114 can include a beer column 202, a rectifier column 204, and a side stripper column 206. Each of the beer column 202, rectifier column 204, and side stripper column 206 are typically multi-tray vessels and operate at sub-atmospheric conditions. The beer column 202 can receive ethanol-laden beer from the fermentation process 112. The beer includes ethanol, water, and milled grain components and can have an ethanol concentration of approximately 17-18% (volume/volume basis). The temperature of the beer entering the beer column 202 may be about 150° F. and may be at a subatmospheric pressure of about 7 psia. The beer column 202 may be operated at a pressure in a range of about 4 psia to about 11 psia or about 5 psia to about 11 psia, with a corresponding temperature range of about 140° F. up to about 165° F. In one embodiment, the operating pressure may be about 7 psia. Temperatures greater than 165° F. can cause flashing within the vessel, increasing the potential for beer or mash to carryover the top of the beer column 202 and into the rectification column 204. Second effect steam from a second set of evaporators 511, 512, 513, 514 provides heat for boiling off the ethanol from the beer in the beer column 202. The source and routing of this second effect steam is described in greater detail below. The range of the second effect steam temperature is a function of the pressure, which can be in a range of about 7.6 psia to about 9.4 psia with a corresponding temperature range of about 180° F. to about 190° F. The second effect steam is mixed directly with the beer as the beer cascades down through the beer column 202. The overhead ethanol vapor leaving the beer column 202 is about 50% ethanol or 100 proof.

Next, the about 100 proof ethanol vapor from the beer column 202 enters the rectifier column 204 where ethanol vapor having a higher concentration of ethanol (190 proof or 95% pure) is generated as an overhead vapor at a pressure of about 4 psia. Accordingly, the operating pressure of the rectifier column 204 may be about 4 psia. The rectifier column 204 can be operated at a subatmospheric pressure in a range of about 2.5 psia to about 6.0 psia. Vapor flowing out of the rectifier column 204 is condensed into a liquid by a condenser 208. The condenser 208 may use cooling water as the condensing medium. The overhead condensed ethanol may be split so that a portion (e.g., two-thirds) is recycled back into the rectifier column 204 and the remainder (e.g., one-third) is sent to a 190 day tank 210 for further processing. The thermal energy or heat that drives the rectifier column 204 is present in the hot 100 proof vapors that enter the rectifier column 204. The bottoms from the rectifier column 204, which have an ethanol concentration of about 20% (or 40 proof), are typically circulated to the side stripper column 206.

The side stripper column 206 strips ethanol from the rectification bottom stream and produces a second stream of about 100 proof vapor that is circulated back into the rectifier column 204 for further dehydration or separation of the ethanol from the distillate stream. The ethanol proof of the vapor circulated back to the rectifier column 204 can have a range of about 60 to about 120. The side stripper column 206 may operate at a pressure of about 7 psia. The side stripper column 206 can be operated at a pressure in a range of about 5 psia to about 9 psia. The bottoms or distillate from the side stripper column 206 is mostly hot water, which can be sent to a condensate tank 120 and/or optionally used in initially slurrying the ground grain.

With continuing reference to FIG. 4, the centrifuge at centrifugation step 116 receives beer bottoms or whole stillage containing mostly water, dissolved materials, unfermented solids and spent fermentation agent from the milled grain and subsequent fermentation process 112. The centrifuge 116 receives the whole stillage and removes the solids known as distiller's grains. In particular, the whole stillage from the beer column 202 can be piped to centrifuge 116 or other separation device, which separates the whole stillage into solids known as distiller's grains and a liquid known as thin stillage or centrate. The distiller's grains can be conveyed to the dryer 122 for further drying. Because distiller's grains can be rich in fiber and protein, they can be used as a feed for livestock. The liquid portion or thin stillage leaving the centrifuge 116 may be sent on or divided into one or more portions, as follows. A portion of the resulting thin stillage can be piped to the evaporation step 118 of the system, which is further discussed in more detail below. A second portion can be piped back to pre-fermentation, e.g., to the eductor 104, as backset to help create a slurry with the ground grain, as discussed above. A third optional portion can be sent to fermentation 112 and/or can be further utilized or processed into an additional component as follows, including but not limited to use in anaerobic digestion, as a nutrient feed source for a biochemical or biofuel fermentation or conversion process, as feed for an herbicide or a fertilizer, utilized as a feed source for zein protein or any other viable usage.

With continuing reference to FIG. 4, the distillation and dehydration step 114 receives the liquid 190 proof hydrous ethanol from the condenser 208 and removes most of the remaining water in that ethanol. In particular, the liquid 190 proof (hydrous) ethanol from the 190 day tank 210 is vaporized via a steam vaporizer 212 to ensure no condensing of the hydrous ethanol occurs in the molecular sieves 214. To that end, the superheated 190 proof ethanol is sent to a series of molecular sieves 214 where excess water is removed to produce about a 99.0% (or greater) by weight ethanol stream commonly referred to as anhydrous ethanol or 200 proof ethanol. The molecular sieves 214 can be multi-column systems containing vessels, vaporizers, regeneration condensers, and reclaim heat exchangers. In one example, each of the molecular sieves 214 include a packed column of desiccant beads that attract water but reject ethanol to remove the water from the hydrous ethanol. The resulting hot 200 proof ethanol vapor leaving the molecular sieve 214 is sent to the evaporation step 118, as further discussed below. Once the desiccant beads are saturated with water, they can be regenerated by pulling a high vacuum, which can be accomplished by taking them offline. The high vacuum flashes the water and any ethanol from the desiccant beads, and the beads are ready to be placed in service again. The vapors released in this regeneration cycle are sent back to the rectifier column 204 to be captured. It should be understood that the molecular sieves 214 may be replaced with other types of dehydration technologies, e.g., steel or ceramic membranes, pervapor separation, or chemical separation, all of which can perform the desired dehydration function.

As shown in FIG. 4, two sets of evaporators, which may be arranged in a series fashion, can be utilized in the evaporation step 118, in part, to reduce or concentrate thin stillage to a thick syrup, which can be fed to the dryer 122 for further drying. The thin stillage may contain approximately 2 to 8% solids, with a range of about 4 to 9%, at the beginning of evaporation, and the resulting syrup may have a solids concentration of 34-36%, with a range of about 25 to 50% solids concentration. The two sets of evaporators, which together provide a double effect evaporation process, can include a first set of evaporators 501, 502, 503, 504, known as first effect evaporators, and a second set of evaporators 511, 512, 513, 514, known as second effect evaporators. Although each set of evaporators is illustrated as having four evaporators, each set could include less than four, e.g., one, two, or three, or more than four evaporators, as needed. With this setup, energy for the beer column 202 and the eductor 104 can be created from the evaporation of water from thin stillage, as discussed next.

Each of the evaporators in the evaporation step 118 can include a shell and tube heat exchanger in which a heating vapor is isolated in the shell side. The set of first effect evaporators are heated by a heating vapor such as clean plant steam from a boiler (not shown) or hot 200 proof ethanol vapor from the molecular sieves 214. In one embodiment, the heating vapor for the evaporators 501, 502, 503 is steam from the plant boiler (not shown), while the heating vapor for evaporator 504 is the hot 200 proof ethanol vapor (at about 2.9 lbs/bu). It should be understood here that various modifications may be made altering which of the first effect evaporators 501, 502, 503, 504 are provided with steam and/or the hot 200 proof ethanol vapor. In one example, 18 lbs/bu of steam from a plant boiler can be provided to first effect evaporators 501, 502, 503 instead of, for example, a standard 16 lbs/bu by (re)directing an additional 2 lbs/bu of steam typically intended for the slurry tank 106 as direct inject steam. The additional pounds, e.g., 2 lbs/bu, of steam produces a corresponding additional 2 lbs/bu of first effect evap steam that can be captured and directed to the eductor 104 on the front end of the dry milling method and system 100. While a reduction and increase in steam of 2 lbs/bu is indicated, it should be understood that more or less steam can be considered, e.g., a 1 lb/bu or 3 lbs/bu reduction/increase, as needed/desired. In one example, the steam increase at the first effect evaporators can be from about 1 lb/bu to about 3 lbs/bu. Generally, the reduction in steam typically at the slurry tank 106 will be offset by an equivalent increase in steam input at the first effect evaporators 501, 502, 503 (see FIG. 4) so as to maintain an overall mass balance in the method and system 100.

Further concerning the setup here with respect to first effect evaporators 501, 502, 503, 504, the clean plant steam may be at a pressure of about 24 psia and a temperature of about 242° F. In another example, the temperature may be in a range of about 240° F. to 245° F. In another example, the clean plant steam may be at a pressure between 14 psia and 23 psia and at a temperature from 209° F. to 235° F. In one example, the hot 200 proof ethanol vapor may be at a pressure of about 50 psia and a temperature of about 280° F. In another example, the hot 200 proof ethanol vapor may be at a pressure in a range of about 30 psia and about 65 psia and at a temperature from about 250° F. to about 300° F. The heating vapor from the incoming steam or hot 200 proof ethanol vapor will condense and exit as condensate or 200 proof liquid ethanol through condensate lines. The steam condensate can be returned to the boiler (not shown). The condensed 200 proof ethanol can be sent through a single exchanger or a series of exchangers (not shown) to exchange additional heat into the 190 proof ethanol liquid feed to dehydration. The cooled 200 proof ethanol, which is the main final product of the ethanol facility, can then be sent to a 200 proof tank (not shown).

With continuing reference to FIG. 4, the tube-side fluid entering the first effect evaporators is shown as thin stillage after separation of the same from whole stillage at the centrifuge 116. For example, at least a portion of the thin stillage can be sent initially to evaporator 501. Another portion of the thin stillage also can be sent to the front end of the method and system 100 as backset to the eductor 104 to help create a slurry with the ground grain, as discussed in detail above. It should be understood here that various modifications may be made altering which of the first effect evaporators 501, 502, 503, 504 are provided with thin stillage. In another embodiment, evap condensate may be utilized instead of or in conjunction with the thin stillage. Here, the thin stillage from centrifuge 116 can enter the top of the evaporator 501 and leave the bottom of the evaporator 501 slightly concentrated. In one example, the thin stillage exiting the evaporator 501 may be split so that a portion is recycled to the top of the evaporator 501 and the remainder enters the next evaporator 502. Similarly, a portion of the thin stillage may be recycled from the bottom of the evaporator 502 to the top of evaporator 502, and so on with evaporators 503 and 504. The concentrated thin stillage (and/or evaporator condensate, if utilized) finally exits the bottom of evaporator 504. The concentrated thin stillage may be referred to as first-concentrated thin stillage after it leaves the first set of evaporators. Liquid that is boiled off or evaporated from the thin stillage in the evaporators 501, 502, 503, 504 can enter a first effect steam line 530 as steam.

Because evaporators 501, 502, 503, 504 receive the highest grade heat input they are collectively called first effect evaporators. The vapor created in the first effect evaporator is recovered and used to heat the second effect evaporators 511, 512, 513, 514. Not only is the first effect steam used to heat the second effect evaporators 511, 512, 513, 514, at least a portion of the first effect steam is diverted and used to heat the cook water and backset mixture at the eductor 104, as discussed in detail above, and that heated process liquid, which includes cook water, backset, and condensed first effect steam, is used to mix with ground grain to form a slurry at the slurry blender 103. The various lines leading to the evaporators may be valved so that any one of the four evaporators 501, 502, 503, 504 can be selectively taken off-line and by-passed, for example, during maintenance work. The ethanol facility can be designed to operate at full capacity with three (or less) first effect evaporators on-line. Thus, any one of the four evaporators can be isolated and shut down for cleaning and maintenance without compromising the operation of the plant. Depending on the facility production rate, it is known by one skilled in the art that the number of first effect evaporators can vary from 1 to more than 4. The total number of evaporators typically is driven by the production volume requirements.

With continuing reference to FIG. 4, the arrangement and operation of the second effect evaporators 511, 512, 513, 514 is somewhat similar to the first effect evaporators 501, 502, 503, 504, except, for example, that they operate at a lower pressure and temperature and are heated by first effect steam collected from first effect evaporators 501, 502, 503, 504. The first effect steam generated by the first effect evaporators can be at a pressure of about 10 psia to about 15 psia and at a temperature of about 195° F. to about 215° F. In one example, the first effect steam generated by the first effect evaporators is at a pressure of about 10 psia to about 13 psia and, in another example, at about 11 psi and at a temperature of about 200° F. The second effect evaporators process the first-concentrated thin stillage from the stillage line 540. Specifically, the first-concentrated thin stillage from the stillage line 540 enters evaporator 511, which further concentrates the thin stillage. The thin stillage exiting the evaporator 511 may be split so that a portion is recycled to the top of the evaporator 511 and the remainder enters the next evaporator 512. In this manner, the thin stillage is concentrated by each of the evaporators 511, 512, 513, 514. The further concentrated thin stillage finally exits evaporator 514 as a syrup that is conveyed via syrup line 542 back to, for example, a syrup storage tank (not shown) and/or the dryer 122.

The steam generated in the second effect evaporators 511, 512, 513, 514 is second effect steam. This relatively low pressure, second effect steam is collected from the various outlets of second effect evaporators 511, 512, 513, 514 by second effect steam line 532. The second effect steam line 532 then conveys the second effect steam to the beer column 202 to heat the same. Because the evaporators 511, 512, 513, 514 are heated by vapors from the first effect evaporators, they are known as second effect evaporators. In one example, the second effect steam is at a pressure of approximately about 7.5 psia to about 8.5 psia and at a temperature of about 180° F. to about 185° F. The first effect steam is condensed with at least a portion of the condensate being sent to the cook water tank 105 at the front end of the method and system 100 to help create a slurry with the ground grain, as discussed in detail above. As with the first effect evaporators, the various lines leading to the evaporators may be valved so that any one of the four evaporators 511, 512, 513, 514 can be selectively taken off-line and by-passed for maintenance allowing for continuous operation. And depending on the facility production rate, it is known by one skilled in the art that the number of first effect evaporators can vary from 1 to more than 4. The total number of evaporators typically is driven by the production volume requirements. It should be recognized that the order of the evaporators through which the thin stillage passes may vary. Other modifications and variations can be contemplated, including the addition of a set of evaporators for a third effect setup, fourth effect setup, etc., as desired, as would be understood by one skilled in the art. Modifying the order of the evaporators through which the thin stillage passes does not affect the order and configuration of the first and second effect steam flows.

With continuing reference to FIG. 4, inside the beer column 202, fermented ethanol present in the beer produced by the fermentation process 112 is boiled out as overhead of about 100 proof vapor with a potential range of 90 to 120 proof. The second effect steam from the second effect evaporators 511, 512, 513, 514 provides the necessary steam to remove about 99.5% or greater of the beer's ethanol as about 100 proof overhead vapor. The quantity of second effect steam needed from evaporators 511, 512, 513, 514 for efficient ethanol recovery and heating at the eductor 104 can determine the evaporation capacity of the evaporation step 118. The steam requirements of the eductor 104 also can determine the evaporation capacity of the evaporation step 118. When the steam requirement of the eductor 104 increases, the evaporation capacity increases, so that more thin stillage can be/may need to be conveyed to the evaporation step 118. Although not specifically illustrated, in one example, the first effect steam provided to the eductor 104 can be replaced by or further include at least a portion of the second effect steam whereat the second effect steam mixes with and further heats incoming process liquid, i.e., the heated cook water and a backset mixture. The heated process liquid, which now further includes condensed second effect steam, can be combined with the milled corn to provide a (more efficiently) heated slurry stream, as discussed above in detail with respect to the first effect steam.

In the end, by decreasing the amount of typical direct inject steam at the slurry tank 106 and correspondingly increasing the amount of incoming steam from the plant boiler(s), for example, to the first effect evaporators 501, 502, 503 to product additional first effect steam and using at least a portion thereof, which can correspond to the reduction of inject steam and the increase in incoming first effect steam, at the eductor to heat the incoming process fluid (e.g., the mixture of cook water and backset), can provide important advantages. For example, there is a resulting reduction in water added to the overall alcohol production method and system 100 through the use of the waste heat (first effect steam) and using the same at the eductor 104 to increase the temperature of the process liquid and, thus, the slurry stream. As a result of there being less overall water, there is less water to evaporate from the system and method 100, and this reduces cost/conserves energy. Energy savings, for example, also can be taken at the dryer(s) 122 on the back end of the process if the evaporators can be taken to higher dried solids. And greater oil yield can be realized for an increase in revenue.

While the present invention has been illustrated by a description of various embodiments and while these embodiments have been described in considerable detail, it is not the intention of the applicant to restrict or in any way limit the scope of the appended claims to such detail. For example, while the use of steam (e.g., first effect steam) and the eductor 104 has been shown and described hereinabove with respect to further heating incoming process liquid, which here is heated cook water and a backset mixture, it should be understood that other process streams/liquids could be heated in a similar manner/fashion as discussed above. Additional advantages and modifications will readily appear to those skilled in the art. Thus, the invention in its broader aspects is therefore not limited to the specific details, representative apparatus and method, and illustrative example shown and described. Accordingly, departures may be made from such details without departing from the scope of applicant's general inventive concept.

1. A method for heating a process liquid used in a slurry stream in a biofuel and/or biochemical production process comprising:
separating thin stillage from whole stillage in a biofuel and/or biochemical production process;
evaporating liquid from a first portion of the separated thin stillage via one or more evaporators to produce steam;
heating a process liquid, which includes a mixture of a second portion of the separated thin stillage and a liquid portion, with a portion of the steam at an eductor whereat the steam mixes with and heats the process liquid, and the steam cools and condenses to liquid thereby providing a heated process liquid, including a mixture of the liquid portion, the second portion of thin stillage, and condensed steam; and
mixing the heated process liquid with a ground grain to provide a heated slurry stream.

2. The method of claim 1 wherein the steam is first and/or second effect steam.

3. The method of claim 1 wherein the steam is first effect steam.

4. The method of claim 1 wherein the liquid portion is a heated liquid portion.

5. The method of claim 1 wherein the steam is at a temperature of from about 195° F. to about 215° F.

6. The method of claim 1 wherein the liquid portion includes evap condensate from one or more evaporators, fresh water, or a combination thereof.

7. The method of claim 1 wherein the heated process liquid is heated by the steam to a temperature from about 195° F. to about 205° F.

8. The method of claim 1 wherein the heated process liquid is heated by the steam to a temperature of about 200° F.

9. The method of claim 1 further comprising heating the heated slurry stream with additional process steam.

10. The method of claim 9 wherein the additional process steam includes about 2 lbs/bu to increase the temperature of the slurry stream.

11. The method of claim 1 wherein the biofuel and/or biochemical production process is an alcohol production process.

12. A method for heating a process liquid used in a slurry stream in a biofuel and/or biochemical production process comprising:
separating thin stillage from whole stillage in a biofuel and/or biochemical production process;
evaporating liquid from a first portion of the separated thin stillage via one or more evaporators to produce a first effect steam;
heating a process liquid, which includes a mixture of a second portion of the separated thin stillage and a heated liquid portion, with a portion of the first effect steam at an eductor whereat the first effect steam mixes with and further heats the process liquid, and the first effect steam cools and condenses to liquid thereby providing a heated process liquid, including a mixture of the heated liquid portion, the second portion of thin stillage, and condensed first effect steam; and
mixing the heated process liquid with a ground grain to provide a heated slurry stream.

13. A system for heating a process liquid used in a slurry stream in a biofuel and/or biochemical production process comprising:
a first apparatus that receives whole stillage and separates thin stillage from the whole stillage;
one or more evaporators that receive all or a portion of the separated thin stillage from the first apparatus, the one or more evaporators configured to evaporate water from the separated thin stillage and produce steam;
an eductor that receives a process liquid, which includes a mixture of a second portion of the separated thin stillage and a liquid portion, and a portion of the steam, whereat the steam mixes with and heats the process liquid, and the steam cools and condenses to liquid thereby providing a heated process liquid, including a mixture of the liquid portion, the second portion of thin stillage, and condensed first effect steam; and
a second apparatus that receives the heated process liquid and a ground grain and whereat the heated process liquid is mixed with the ground grain to provide a heated slurry stream.

14. The system of claim 13 wherein the first apparatus is selected from a centrifuge.

15. The system of claim 13 wherein the second apparatus is selected from a slurry blender.

16. The system of claim 13 wherein the steam is at a temperature of from about 195° F. to about 215° F.

17. The system of claim 13 wherein the liquid portion includes evap condensate from the one or more evaporators, fresh water, or a combination thereof.

18. The system of claim 13 wherein the heated process liquid is heated by the steam to a temperature from about 195° F. to about 205° F.

19. The system of claim 13 wherein the heated process liquid is heated by the steam to a temperature of about 200° F.

20. The system of claim 13 wherein the steam is first effect steam.

21. The system of claim 13 wherein the liquid portion is a heated liquid portion.

22. The system of claim 13 wherein the biofuel and/or biochemical production process is an alcohol production process.
